(19) United States
(12) Patent Application Publication
(10) Pub. No.: US 2008/0293588 A1
(43) Pub. Date: Nov. 27, 2008

(54) NANODISK CODES

(75) Inventors: Chad A. Mirkin, Wilmette, IL (US); Jill E. Millstone, Jacksonville, FL (US); Lidong Qin, Evanston, IL (US); Matthew J. Banholzer, Evanston, IL (US)

Correspondence Address: MARSHALL, GERSTEIN & BORUN LLP, 233 S. WACKER DRIVE, SUITE 6300, SEARS TOWER, CHICAGO, IL, 60606, US

(73) Assignee: NORTHWESTERN UNIVERSITY, Evanston, IL (US)

(21) Appl. No.: 12/119,081

(22) Filed: May 12, 2008

Related U.S. Application Data
(60) Provisional application No. 60/917,574, filed on May 11, 2007.

(51) Int. Cl. C40B 30/04

(52) U.S. Cl. 506/9

(57) ABSTRACT

The invention relates to nanodisk codes and methods of using the nanodisk codes in encoding and detection schemes. In one aspect, the invention relates to nanodisk codes having a binary encoding scheme and functionalized such that the encoding of the nanodisk codes is detectable.

### CROSS REFERENCE TO RELATED APPLICATION

This application claims the benefit of U.S. Provisional Application No. 60/917,574, filed May 11, 2007, which is incorporated herein by reference in its entirety.

### STATEMENT OF GOVERNMENTAL INTEREST

This invention was made with government support under grant F49620-01-1-0401 awarded by the Air Force Office of Scientific Research and under grant FA8650-06-C-7617 awarded by the Defense Advanced Research Projects Agency and the Air Force Research Laboratory. The government has certain rights in the invention.

### FIELD OF THE INVENTION

The invention relates to nanodisk codes and methods of using the same in encoding and detection schemes. In particular, the invention relates to nanodisk codes functionalized with Raman active chromophores and methods of using the same in encoding schemes detectable by Raman spectroscopy.

### BACKGROUND OF THE INVENTION

Encoded materials are used for many applications, including cryptography, computation, brand protection, and labeling in biological and chemical diagnostics (P. Zanardi et al., Phys. Rev. Lett. 81, 4752-55 (1998); Y. C. Cao et al., Science 297, 1536-40 (2002)). Nanostructures are useful for encoding applications because they can be dispersed or hidden in a variety of media due to their small size, and their chemical and physical properties can be rationally designed in a variety of ways (S. J. Hurst et al., Angew. Chem. Int. Ed. 45, 2672-92 (2006); N. L. Rosi et al., Chem. Rev. 105, 1547-62 (2005)).

Certain types of nano- and micromaterials are beginning to find application as probes in sensitive and selective molecular diagnostic systems (J.-M. Nam et al., Science 301, 1884-86 (2003)). These materials include nanoparticles labeled with Raman chromophores (H. Fenniri et al., J. of Comb. Chem. 8, 192-98 (2006)); striped nanorods (S. R. Nicewarner-Peña et al., Science 294, 137-41 (2001); J. B.-H. Tok et al., Angew. Chem. Int. Ed. 45, 6900-04 (2006)); beads modified with fluorophores (R. Jin et al., Small 2, 375-80 (2006); R. Wilson et al., Angew. Chem. Int. Ed. 45, 6104-17 (2006)); and beads modified with quantum dots (H.-Q. Wang et al., J. Fluorescence 17, 133-38 (2007)). Striped nanorods are an interesting class of materials because they are dispersible entities, allow for massive encoding based upon the length and location of individual chemical blocks within the structures, and can be functionalized using conventional surface chemistries (S. R. Nicewarner-Pena et al., Science 294, 137-41 (2001)). These nanostructures are typically identified by reflectivity or fluorescence. However, the high degree of overlap between common fluorescent labels, the quenching properties of the metal blocks that comprise these structures, and the difficulty in resolving differences in metal reflectivity represent limitations for these systems (J. B.-H. Tok et al., Angew. Chem. Int. Ed. 45, 6900-04 (2006); R. L. Stoermer et al., J. Am. Chem. Soc. 128, 13243-54 (2006)). Thus, a need exists for materials that can be used in encoding and detection applications.

### SUMMARY OF THE INVENTION

Disclosed herein are nanodisk codes for use in encoding and detection schemes.

One aspect of the invention is directed to methods of using a nanodisk code having at least one nanodisk pair and a separation gap. The nanodisk pair includes two nanodisks separated by a disk gap. The arrangement of the nanodisk pair and the separation gap along the nanodisk code encodes the nanodisk code. The nanodisk codes are synthesized using on wire lithography (OWL) such that the nanodisk thicknesses, the disk gaps, and the separation gaps are controlled. In some embodiments, the arrangement of the nanodisk pair and the separation gap of the nanodisk code corresponds to a binary encoding scheme, wherein the presence of a nanodisk pair represents the number one in the binary encoding scheme and the absence of a nanodisk pair represents a zero. In some embodiments, the nanodisk codes are functionalized with a spectroscopic label. In various embodiments, the spectroscopic label is a Raman chromophore. These Raman-active nanodisk codes can be characterized using Raman spectroscopy. The structure of the nanodisk codes enables surface-enhanced Raman scattering (SERS).

Another aspect of the invention is directed to a method of detecting a target analyte using a molecule-modified nanodisk code comprising a nanodisk code and an associated molecule. The method includes mixing the molecule-modified nanodisk codes having at least two nanodisk separated by a disk gap to form a nanodisk pair, at least one separation gap, and a molecule attached to a portion of the nanodisk code surface with a sample containing, or suspected of containing, the target analyte under conditions to permit binding of the analyte to the molecule, and detecting the analyte bound to the molecule-modified nanodisk code, wherein the binding of the analyte to the molecule-modified nanodisk code produces a detection event. The arrangement of the nanodisk pairs and the separation gap encodes the nanodisk codes. The molecule-modified nanodisk codes can further include a spectroscopic label attached to a surface of the nanodisk pairs.

Still another aspect of the invention is to provide a method for detecting a target oligonucleotide using an oligonucleotide-modified nanodisk code. The method includes contacting the oligonucleotide-modified nanodisk code and a reporter oligonucleotide with a sample containing, or suspected of containing, the target oligonucleotide under conditions to permit a binding event, and detecting the binding event, wherein the binding event produces a signal and the presence or absence of the signal corresponds to the presence or absence of the target oligonucleotide. The oligonucleotide-modified nanodisk code includes at least two nanodisks separated by a disk gap to form a nanodisk pair, and at least one separation gap. The arrangement of the nanodisk pair and the separation gap encodes the nanodisk codes. At least a portion of the oligonucleotide-modified nanodisk code is functionalized with an oligonucleotide that is at least partially complementary to a first portion of the target oligonucleotide. The reporter oligonucleotide includes a reporter molecule and an oligonucleotide that is at least partially complementary to second portion of the target oligonucleotide.

Still another aspect of the invention is a kit for detection of analytes using a molecule-modified nanodisk code, which includes a plurality of molecule-modified nanodisk codes having different encodings and functionalized with different molecules such that different analytes can be detected by selection of the proper molecule-modified nanodisk code. The kit may further include instructions.

### BRIEF DESCRIPTION OF THE DRAWINGS

FIG. 1A is a schematic representation of 13 possible 5-disk pair nanodisk codes with corresponding binary codes.

FIG. 1B is a schematic representation of a method of synthesizing and functionalizing nanodisk codes.

FIG. 1C is two- and three-dimensional scanning Raman microscopy images of a 11111-encoded nanodisk code.

FIG. 2A is an optical image and a scanning Raman three-dimensional image of an Au—Ni nanorod and a 11111-encoded nanodisk code.

FIG. 2B is a Raman spectra taken from the Au—Ni nanorod and the 11111-encoded nanodisk code of FIG. 2A.

FIG. 2C is an optical image and a scanning Raman three-dimensional image of an Au nanorod-disk pair array.

FIG. 2D is a Raman spectra taken from the nanorod section and the nanodisk section of the nanorod-disk pair array of FIG. 2C.

FIG. 3A are three-dimensional scanning Raman images showing the results for DNA detection using oligonucleotide-modified nanodisk codes for target concentrations of 5 μM, 5 nM, 500 μM, and 5 μM. The control experiment with only reporter oligonucleotide and oligonucleotide-modified nanodisk code strands and no target did not give a readable response.

FIG. 3B is a schematic representation of a three-stranded DNA system, including DNA sequences used, for DNA detection using the nanodisk codes of FIG. 3A.

FIG. 3C is a Raman spectra taken from selected areas of the three-dimensional scanning Raman images of FIG. 3A.

FIG. 4A is a three-dimensional Raman image of a 11011-encoded nanodisk code after functionalization and hybridization with 100 fM concentration and 40× reporter nanoparticles for a nanoparticle-target-nanodisk code sandwich assay.

FIG. 4B is a field effect scanning electron microscopy image of the nanoparticles immobilized on a nanodisk surface of the nanodisk code of FIG. 4A.

FIG. 5A is a Raman spectra of Cy5 and TAMRA reporter molecules from a reporter oligonucleotide immobilized on a nanodisk code after DNA hybridization.

FIG. 5B is a schematic representation of a 11011-encoded and 10101-encoded oligonucleotide-modified nanodisk code nanostructures showing the DNA sequence of the target DNA, reporter oligonucleotide, and oligonucleotide-modified nanodisk code.

FIG. 5C is a full-spectrum three-dimensional scanning Raman image of the 11011-encoded and 10101-encoded nanodisk codes of FIG. 5B functionalized with different single-stranded DNA sequences.

FIG. 5D is a filtered three-dimensional scanning Raman image of the image in FIG. 5C, showing the unique Raman peak from the Cy5 probe of the 11011-encoded nanodisk code of FIG. 5B.

FIG. 5E is a filtered three-dimensional scanning Raman image of the image in FIG. 5C, showing the unique Raman peak from the TAMRA probe of the 10101-encoded nanodisk code of FIG. 5B.

FIG. 6A is a field effect scanning electron microscopy image of 11111-encoded nanodisk code.

FIG. 6B is a field effect scanning electron microscopy image of 11011-encoded nanodisk code.

FIG. 6C is a field effect scanning electron microscopy image of 10101-encoded nanodisk code.

FIG. 6D is a field effect scanning electron microscopy image of a nanorod before undergoing an OWL process.

FIG. 6E is a field effect scanning electron microscopy image of a nanorod section/nanodisk pair hybrid structure.

FIG. 7 is a field effect scanning electron microscopy image of a 10101-encoded nanodisk code employed in an nanoparticle-target-nanodisk code sandwich assay for a 50 nM target concentration, showing that the AU nanoparticles are immobilized on all three disk pairs, and most notably in the interdisk gap.

### DETAILED DESCRIPTION

The invention is directed to nanodisk codes that are detectable and methods of using the nanodisk codes in encoding and detection schemes. The following disclosure is primarily directed to Raman but can readily be extended to other methods. More particularly, the invention is directed to nanodisk codes that can be encoded both physically, for example, in a barcode pattern, and spectroscopically, for example, using varying Raman activity. This multi-level approach to encoding nanostructures avoids some of the limitations of the striped barcodes by transitioning weaknesses, such as fluorescence quenching, into advantages in the context of the Raman format.

The small size of the nanodisk codes makes them well suited for covert encoding strategies. Additionally, a large number of nanodisk codes can be generated simply by varying the number and location of the pairs, as well as the type of spectroscopic labeling agents used.

### Nanodisk Codes

A nanodisk code includes one or more nanodisk pairs. A nanodisk pair includes two nanodisks separated by a disk gap. Separation of adjacent nanodisk pairs is achieved using separation gaps. In one aspect, a separation gap is, also, disposed in a space between the nanodisk pair and an end of the nanodisk code.

Nanodisk thicknesses include, but are not limited to, ranges of about 20 nm to about 500 nm, about 40 nm to about 250 nm, and about 50 nm to about 120 nm. Specific examples of disk thicknesses include 35, 40, 45, 50, 55, 60, 65, 75, 80, 85, 90, 95, 100, 105, 110, 115, 120, 125, 130, 135, 140, 145, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, and 500 nm. In some cases, the disk thickness of the nanodisk is at least 500 nm and up to 2 μm.

Nanodisk diameters includes, but are not limited to, ranges of about 10 nm to 400 nm. Other nanodisk diameters include in the range of about 20 nm to 200 nm. Specific examples of nanodisk diameters include 13, 15, 20, 25, 30, 35, 40, 45, 50, 55, 60, 65, 75, 80, 85, 90, 95, 100, 105, 110, 115, 120, 125, 130, 135, 140, 145, 150, 160, 170, 180, 190, 200, 210, 220, 230, 240, 250, 260, 270, 280, 290, 300, 310, 320, 330, 340, 350, 360, 370, 380, 390, and 400 nm.

In one aspect, the disk gap between the two nanodisks of a nanodisk pair is between about 2 nm and 500 nm. Other disk gap ranges contemplated include in the range of about 5 to 160 nm. Specific examples of gap sizes include 5, 10, 15, 20, 25, 30, 35, 40, 45, 50, 55, 60, 65, 75, 80, 85, 90, 95, 100, 105, 110, 115, 120, 125, 130, 135, 140, 145, 150, 160, 170, 180, 190, 200, 210, 220, 230, 240, 250, 260, 270, 280, 290, 300, 310, 320, 330, 340, 350, 360, 370, 380, 390, 400, 410, 420, 430, 440, 450, 460, 470, 480, 490, and 500 nm.

The length of the separation gap depends upon the size of the nanodisk code and the specific encoding desired. Typically, the separation gap length is at least two times greater, preferably three times longer, than the total length of the nanodisk pair array. For example, a nanodisk pair array composed of two nanodisk pairs each having two 120 nm thick disks separated by a 30 nm gap can be separated from each other by a 1 μm separation gap. For nanodisk pairs having larger disk thicknesses and gaps, larger separation gaps are needed.

An arrangement of the nanodisk pairs and the separation gaps encodes the nanodisk code. In one aspect, a binary coding scheme can be assigned to the nanodisk codes, wherein the presence of a disk pair is represented by the number one, and the absence of a disk pair is represented by a zero. For example, if a middle (e.g., third) disk pair in a five pair array is intentionally omitted a code of 11011 is generated. Intentional omission of a nanodisk pair is achieved by increasing the size of the separation gap between the newly adjacent disk pairs. Thus, in the example above, the separation gap between the second disk pair and the fourth disk pair would be approximately doubled by the omission of the third disk pair. The nanodisk codes can be easily tailored using a variety of code parameters including chemical label type, disk pair number, and separation gap size. In some cases the binary encoding scheme can be based on nanodisk codes having from 1 to 25 nanodisk pairs. Specific examples include 1, 2, 3, 4, 5, 6, 7, 8, 9, 10, 11, 12, 13, 14, 15, 16, 17, 18, 19, 20, 21, 22, 23, 24, and 25 nanodisk pairs.

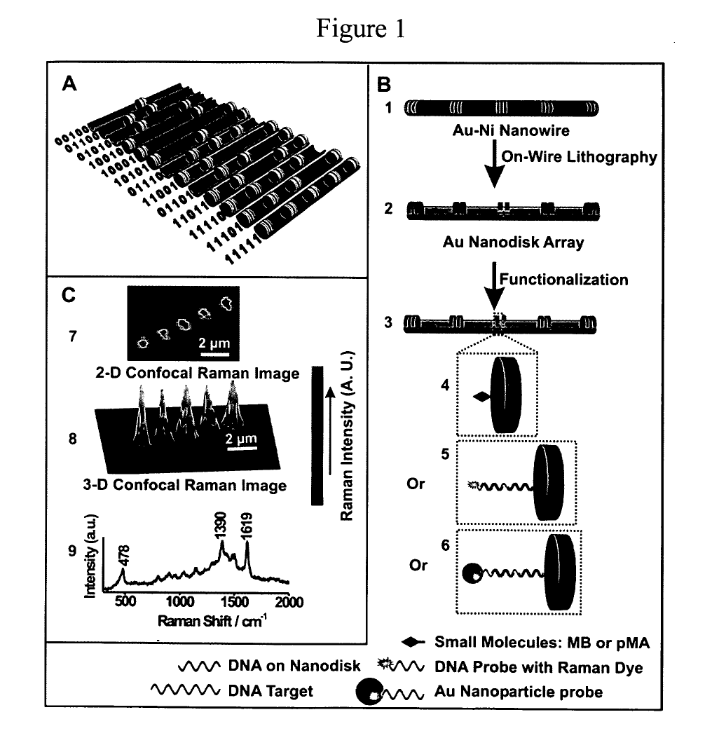

Referring to FIG. 1B, in one aspect, the nanodisk codes are functionalized with spectroscopic labeling agents to form spectroscopically-active nanodisk codes 3. The spectroscopically-active nanodisk codes can be identified by a variety of spectroscopic methods such as fluorescence, Raman, UV, and the like.

In one aspect, the nanodisk codes are functionalized with Raman chromophores to produce Raman-active nanodisk codes 4 that can be identified by Raman spectroscopy. Arrays of nanodisks, once functionalized with Raman chromophores, can take advantage of the well-know surface-enhanced Raman scattering (SERS) phenomenon (C. L. Haynes et al., Analytical Chemistry 77, 338A-46A (2005)). See U.S. Patent Publication No. 2007/0077429; and U.S. patent application Ser. No. 11/372,583, each of which is herein incorporated by reference. In one aspect, the nanodisk codes are functionalized with a Raman chromphore to take advantage of the SERS phenomenon. Examples of Raman chromophores include, but are not limited to, 4-(4-aminophenylazo)phenylarsonic acid monosodium salt, arsenazo I, basic fuchsin, Chicago sky blue, direct red 81, disperse orange 3,2-(4-hydroxyphenylazo)-benzoic acid (HABA), erythrosine B, trypan blue, ponceau S, ponceau SS, 1,5-difluoro-2,4-dinitrobenzene, methylene blue (MB), and p-dimethlyaminoazobenzene pMA).

A larger number of encodings for the nanodisk codes can be generated simply by varying the number and location of the nanodisk pairs and separation gaps as well as the type and number of spectroscopic labeling agents used.

### Formation of Nanodisk Codes

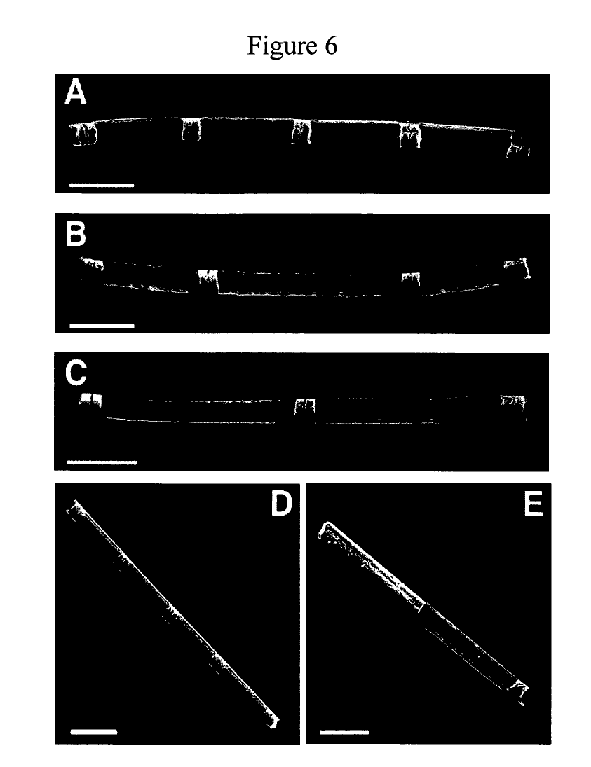

Referring to FIGS. 1B and 6D, in one aspect, nanodisk codes are prepared from nanorods. The nanorods may be synthesized, for example, using template-directed electrochemical synthesis. As used herein, “nanorods” refers to small structures that are less than 10 μm, and preferably less than 5 μm, in any one dimension and that have a length to width ratio greater than one.

The nanorods are multicomponent in nature. As used herein, “multicomponent” refers to an entity that comprises more than one type of material. A multicomponent nanorod refers to a nanorod having more than one type of material, for example, a metal component and a sacrificial metal.

The metal component of the nanorod can be any metal compatible with in situ electrochemical deposition. The segments of the metal component are deposited in pairs along the length of the nanorod. Examples of such metals include, but are not limited to indium-tin-oxide, titanium, platinum, titanium tungstide, gold, silver, nickel, copper, and mixtures thereof.

As used herein, the term “sacrificial metal” refers to a metal that, in one aspect, is dissolved under the proper chemical conditions. The segments of the sacrificial metal may be deposited in the spaces between metal component segments and between a metal component segment and an end of the nanorod. Examples of sacrificial metals includes, but are not limited to, nickel which is dissolved by nitric acid, and silver which is dissolved by a methanol/ammonia/hydrogen peroxide mixture.

Nanodisk codes are formed, in one aspect, by etching the nanorods to remove the sacrificial metal segments to form the disk gaps and the separation gaps. The metal component segments remaining after etching form the nanodisks. The use of metals having different chemical and electrical properties allows for the creation of the disk gaps and the separation gaps in these nanodisk codes when the nanorod is treated with a solution that dissolves one metal of the nanorod while the other metal is unaffected.

As used herein, the term “etching” refers to a process of dissolving a sacrificial metal segment using conditions suitable for dissolving or removing the metal comprising the sacrificial metal segment. As mentioned above, such etching solutions include, but are not limited to, nitric acid and a methanol/ammonia/hydrogen peroxide mixture.

Referring to FIG. 1B, in one aspect, the nanodisk code is formed by performing on wire lithography (OWL) on a nanorod. OWL allows one to tailor the physical and chemical structure of nanorods to generate a class of nanostructures not previously accessible by conventional synthetic or lithographic processes (L. Qin et al., Science 309, 113 (2005)). Specifically, OWL can be used to make dispersible, segmented nanorod structures of fixed diameters with well-defined metal block sizes along the length of the nanostructure. Separation gaps between the nanodisk pairs can be fabricated with a length of from approximately 2 nm to many micrometers.

OWL is based upon manufacturing segmented nanorods comprising at least two materials; one that is susceptible to, and one that is resistant to, wet chemical etching. There are a variety of material pairs that can be used. Au—Ag and Au—Ni are two such examples of metal pairs of differing chemical properties. The sacrificial metal in these pairs is Ag and Ni, respectively. However, any combination of metals having contrasting susceptibility to chemical etching conditions may be used.

### Oligonucleotides

As used herein, the term “oligonucleotide” refers to a single-stranded oligonucleotide having natural and/or unnatural nucleotides. Throughout this disclosure, nucleotides are alternatively referred to as nucleobases. The oligonucleotide can be a DNA oligonucleotide, an RNA oligonucleotide, or a modified form of either a DNA oligonucleotide or an RNA oligonucleotide.

Naturally occurring nucleobases include adenine (A), guanine (G), cytosine (C), thymine (T) and uracil (U) as well as non-naturally occurring nucleobases such as xanthine, diaminopurine, 8-oxo-N⁶-methyladenine, 7-deazaxanthine, 7-deazaguanine, N⁴,N⁴-ethanocytosin, N′,N′-ethano-2,6-diaminopurine, 5-methylcytosine (mC), 5-(C₃-C₆)-alkynyl-cytosine, 5-fluorouracil, 5-bromouracil, pseudoisocytosine, 2-hydroxy-5-methyl-4-tr-iazolopyridin, isocytosine, isoguanine, inosine, and the “unnatural” nucleobases include those described in U.S. Pat. No. 5,432,272 and Freier et al. Nucleic Acids Research, 25:4429-4443 (1997). The term “nucleobase” thus includes not only the known purine and pyrimidine heterocycles, but also heterocyclic analogues and tautomers thereof. Further naturally and non-naturally occurring nucleobases include those disclosed in U.S. Pat. No. 3,687,808; in Sanghvi, Antisense Research and Application, Crooke and B. Lebleu, eds., CRC Press, 1993, Chapter 15; in Englisch et al., Angewandte Chemie, International Edition, 30:613-722 (1991); and in the Concise Encyclopedia of Polymer Science and Engineering, J. I. Kroschwitz Ed., John Wiley & Sons, 1990, pages 858-859, Cook, Anti-Cancer Drug Design, 6, 585-607 (1991), each of which are hereby incorporated by reference in their entirety. Nucleobase also includes compounds such as heterocyclic compounds that can serve like nucleobases including certain “universal bases” that are not nucleosidic bases in the most classical sense but serve as nucleosidic bases. Especially mentioned as universal bases are 3-nitropyrrole, optionally substituted indoles (e.g., 5-nitroindole), and optionally substituted hypoxanthine. Other desirable universal bases include, pyrrole, diazole or triazole derivatives, including those universal bases known in the art. Modified forms of oligonucleotides are also contemplated which include those having at least one modified internucleotide linkage. In one embodiment, the oligonucleotide is all or in part a peptide nucleic acid. Other modified internucleoside linkages include at least one phosphorothioate linkage. Still other modified oligonucleotides include those comprising one or more universal bases. The oligonucleotide incorporated with the universal base analogues is able to function as a probe in hybridization, and as a primer in PCR and DNA sequencing. Examples of universal bases include but are not limited to 5′-nitroindole-2′-deoxyriboside, 3-nitropyrrole, inosine and pypoxanthine.

Modified oligonucleotide backbones containing a phosphorus atom include, for example, phosphorothioates, chiral phosphorothioates, phosphorodithioates, phosphotriesters, aminoalkylphosphotriesters, methyl and other alkyl phosphonates including 3′-alkylene phosphonates, 5′-alkylene phosphonates and chiral phosphonates, phosphinates, phosphoramidates including 3′-amino phosphoramidate and aminoalkylphosphoramidates, thionophosphoramidates, thionoalkylphosphonates, thionoalkylphosphotriesters, selenophosphates and boranophosphates having normal 3′-5′ linkages, 2′-5′ linked analogs of these, and those having inverted polarity wherein one or more internucleotide linkages is a 3′ to 3′, 5′ to 5′ or 2′ to 2′ linkage. Also contemplated are oligonucleotides having inverted polarity comprising a single 3′ to 3′ linkage at the 3′-most internucleotide linkage, i.e. a single inverted nucleoside residue which may be abasic (the nucleotide is missing or has a hydroxyl group in place thereof). Salts, mixed salts and free acid forms are also contemplated. Representative United States patents that teach the preparation of the above phosphorus-containing linkages include, U.S. Pat. Nos. 3,687,808; 4,469,863; 4,476,301; 5,023,243; 5,177,196; 5,188,897; 5,264,423; 5,276,019; 5,278,302; 5,286,717; 5,321,131; 5,399,676; 5,405,939; 5,453,496; 5,455,233; 5,466,677; 5,476,925; 5,519,126; 5,536,821; 5,541,306; 5,550,111; 5,563,253; 5,571,799; 5,587,361; 5,194,599; 5,565,555; 5,527,899; 5,721,218; 5,672,697 and 5,625,050, the disclosures of which are incorporated by reference herein.

Modified oligonucleotide backbones that do not include a phosphorus atom therein have backbones that are formed by short chain alkyl or cycloalkyl internucleoside linkages, mixed heteroatom and alkyl or cycloalkyl internucleoside linkages, or one or more short chain heteroatomic or heterocyclic internucleoside linkages. These include those having morpholino linkages; siloxane backbones; sulfide, sulfoxide and sulfone backbones; formacetyl and thioformacetyl backbones; methylene formacetyl and thioformacetyl backbones; riboacetyl backbones; alkene containing backbones; sulfamate backbones; methyleneimino and methylenehydrazino backbones; sulfonate and sulfonamide backbones; amide backbones; and others having mixed N, O, S and CH₂ component parts. See, for example, U.S. Pat. Nos. 5,034,506; 5,166,315; 5,185,444; 5,214,134; 5,216,141; 5,235,033; 5,264,562; 5,264,564; 5,405,938; 5,434,257; 5,466,677; 5,470,967; 5,489,677; 5,541,307; 5,561,225; 5,596,086; 5,602,240; 5,610,289; 5,602,240; 5,608,046; 5,610,289; 5,618,704; 5,623,070; 5,663,312; 5,633,360; 5,677,437; 5,792,608; 5,646,269 and 5,677,439, the disclosures of which are incorporated herein by reference in their entireties.

Modified oligonucleotides includes oligonucleotides wherein both one or more sugar and/or one or more internucleotide linkage of the nucleotide units are replaced with “non-naturally occurring” groups. In one aspect, this embodiment contemplates a peptide nucleic acid (PNA). In PNA compounds, the sugar-backbone of an oligonucleotide is replaced with an amide containing backbone. See, for example U.S. Pat. Nos. 5,539,082; 5,714,331; and 5,719,262, and Nielsen et al., Science, 1991, 254, 1497-1500, the disclosures of which are herein incorporated by reference.

Other linkages between nucleotides and unnatural nucleotides contemplated for the disclosed oligonucleotides include those described in U.S. Pat. Nos. 4,981,957; 5,118,800; 5,319,080; 5,359,044; 5,393,878; 5,446,137; 5,466,786; 5,514,785; 5,519,134; 5,567,811; 5,576,427; 5,591,722; 5,597,909; 5,610,300; 5,627,053; 5,639,873; 5,646,265; 5,658,873; 5,670,633; 5,792,747; and 5,700,920; U.S. Patent Publication No. 20040219565; International Patent Publication Nos. WO 98/39352 and WO 99/14226; Mesmaeker et al., Current Opinion in Structural Biology 5:343-355 (1995) and Susan M. Freier and Karl-Heinz Altmann, Nucleic Acids Research, 25:4429-4443 (1997).

In one aspect, nanodisk codes for use in the methods provided are functionalized with an oligonucleotide, or modified form thereof, which is from about 5 to about 150 nucleotides in length. Methods are also contemplated wherein the oligonucleotide is about 5 to about 140 nucleotides in length, about 5 to about 130 nucleotides in length, about 5 to about 120 nucleotides in length, about 5 to about 110 nucleotides in length, about 5 to about 100 nucleotides in length, about 5 to about 90 nucleotides in length, about 5 to about 80 nucleotides in length, about 5 to about 70 nucleotides in length, about 5 to about 60 nucleotides in length, about 5 to about 50 nucleotides in length about 5 to about 45 nucleotides in length, about 5 to about 40 nucleotides in length, about 5 to about 35 nucleotides in length, about 5 to about 30 nucleotides in length, about 5 to about 25 nucleotides in length, about 5 to about 20 nucleotides in length, about 5 to about 15 nucleotides in length, about 5 to about 10 nucleotides in length, and all oligonucleotides intermediate in length of the sizes specifically disclosed to the extent that the oligonucleotide is able to achieve the desired result. Accordingly, oligonucleotides of 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98, 99, and 100 nucleotides in length are contemplated.

### Oligonucleotide Sequences and Hybridization

In one aspect, the nanodisk codes utilized in the methods provided has an oligonucleotide attached to it. In another aspect, a report oligonucleotide is provided in addition to the oligonucleotide-modified nanodisk code. Each oligonucleotide-modified nanodisk code and reporter oligonucleotide has the ability to hybridize to a portion of a target oligonucleotide having a sequence sufficiently complementary. In various aspects, the oligonucleotide of oligonucleotide-modified nanodisk code or the reporter oligonucleotide are 100% complementary to a portion of the target oligonucleotide, i.e., a perfect match, while in other aspects, the oligonucleotides are at least (meaning greater than or equal to) about 95% complementary to portions of the target oligonucleotide over the length of the oligonucleotide, at least about 90%, at least about 85%, at least about 80%, at least about 75%, at least about 70%, at least about 65%, at least about 60%, at least about 55%, at least about 50%, at least about 45%, at least about 40%, at least about 35%, at least about 30%, at least about 25%, at least about 20% complementary to portions of the target oligonucleotide over the length of the oligonucleotide.

Methods of making oligonucleotides of a predetermined sequence are well-known. See, e.g., Sambrook et al., Molecular Cloning: A Laboratory Manual (2nd ed. 1989) and F. Eckstein (ed.) Oligonucleotides and Analogues, 1st Ed. (Oxford University Press, New York, 1991). Solid-phase synthesis methods are preferred for both oligoribonucleotides and oligodeoxyribonucleotides (the well-known methods of synthesizing DNA are also useful for synthesizing RNA). Oligoribonucleotides and oligodeoxyribonucleotides can also be prepared enzymatically. Non-naturally occurring nucleobases can be incorporated into the oligonucleotide, as well. See, e.g., U.S. Pat. No. 7,223,833; Katz, J. Am. Chem. Soc., 74:2238 (1951); Yamane, et al., J. Am. Chem. Soc., 83:2599 (1961); Kosturko, et al., Biochemistry, 13:3949 (1974); Thomas, J. Am. Chem. Soc., 76:6032 (1954); Zhang, et al., J. Am. Chem. Soc., 127:74-75 (2005); and Zimmermann, et al., J. Am. Chem. Soc., 124:13684-13685 (2002).

“Hybridization” means an interaction between two strands of nucleic acids by hydrogen bonds in accordance with the rules of Watson-Crick DNA complementarity, Hoogstein binding, or other sequence-specific binding known in the art. Hybridization can be performed under different stringency conditions known in the art. These hybridization conditions are well known in the art and can readily be optimized for the particular system employed. See, e.g., Sambrook et al., Molecular Cloning: A Laboratory Manual (2nd ed. 1989). Preferably stringent hybridization conditions are employed. Under appropriate stringency conditions, hybridization between the two complementary strands could reach about 60% or above, about 70% or above, about 80% or above, about 90% or above, about 95% or above, about 96% or above, about 97% or above, about 98% or above, or about 99% or above in the reactions.

Faster hybridization can be obtained by freezing and thawing a solution containing the oligonucleotide to be detected and the oligonucleotide-modified nanodisk codes. The solution may be frozen in any convenient manner, such as placing it in a dry ice-alcohol bath for a sufficient time for the solution to freeze (generally about 1 minute for 100 μL of solution). The solution must be thawed at a temperature below the thermal denaturation temperature, which can conveniently be room temperature for most combinations of oligonucleotide-modified nanodisk codes and target oligonucleotides. The hybridization is complete, and the detectable change may be observed, after thawing the solution. The rate of hybridization can also be increased by warming the solution containing the target analyte and the oligonucleotide-modified nanodisk code to a temperature below the dissociation temperature (Tₘ) for the complex formed between the oligonucleotide on oligonucleotide-modified nanodisk code and the target analyte. Alternatively, rapid hybridization can be achieved by heating above the dissociation temperature (Tₘ) and allowing the solution to cool. The rate of hybridization can also be increased by increasing the salt concentration (e.g., from 0.1 M to 0.3 M sodium chloride).

### Oligonucleotide Attachment to Nanodisk Code

Referring to FIG. 1B, an oligonucleotide-modified nanodisk code is a nanodisk code functionalized with an oligonucleotide. Methods of functionalizing the oligonucleotides to attach to a surface of a nanoparticle are well known in the art. See Whitesides, Proceedings of the Robert A. Welch Foundation 39th Conference On Chemical Research Nanophase Chemistry, Houston, Tex., pages 109-121 (1995). See also, Mucic et al. Chem. Comm. 555-557 (1996) (describes a method of attaching 3′ thiol DNA to flat gold surfaces; this method can be used to attach oligonucleotides to nanoparticles). These methods can be used to functionalize the nanodisks of the nanodisk code with an oligonucleotide. The alkanethiol method can also be used to attach oligonucleotides to other metal, semiconductor and magnetic colloids and to the other nanoparticles listed above. Other functional groups for attaching oligonucleotides to solid surfaces include phosphorothioate groups (see, e.g., U.S. Pat. No. 5,472,881 for the binding of oligonucleotide-phosphorothioates to gold surfaces), substituted alkylsiloxanes (see, e.g., Burwell, Chemical Technology, 4:370-377 (1974) and Matteucci and Caruthers, J. Am. Chem. Soc., 103:3185-3191 (1981) for binding of oligonucleotides to silica and glass surfaces, and Grabar et al., Anal Chem., 67:735-743 for binding of aminoalkylsiloxanes and for similar binding of mercaptoaklylsiloxanes). Oligonucleotides terminated with a 5′ thionucleoside or a 3′ thionucleoside may also be used for attaching oligonucleotides to solid surfaces. The following references describe other methods which may be employed to attached oligonucleotides to nanoparticles: Nuzzo et al., J. Am. Chem. Soc., 109:2358 (1987) (disulfides on gold); Allara and Nuzzo, Langmuir, 1:45 (1985) (carboxylic acids on aluminum); Allara and Tompkins, J. Colloid Interface Sci., 49:410-421 (1974) (carboxylic acids on copper); Iler, The Chemistry Of Silica, Chapter 6, (Wiley 1979) (carboxylic acids on silica); Timmons and Zisman, J. Phys. Chem., 69:984-990 (1965) (carboxylic acids on platinum); Soriaga and Hubbard, J. Am. Chem., Soc., 104:3937 (1982) (aromatic ring compounds on platinum); Hubbard, Acc. Chem., Res., 13:177 (1980) (sulfolanes, sulfoxides and other functionalized solvents on platinum); Hickman et al., J. Am. Chem. Soc., 111:7271 (1989) (isonitriles on platinum); Maoz and Sagiv, Langmuir, 3:1045 (1987) (silanes on silica); Maoz and Sagiv, Langmuir, 3:1034 (1987) (silanes on silica); Wasserman et al., Langmuir, 5:1074 (1989) (silanes on silica); Eltekova and Eltekov, Langmuir, 3:951 (1987) (aromatic carboxylic acids, aldehydes, alcohols and methoxy groups on titanium dioxide and silica); Lec et al., J. Phys. Chem., 92:2597 (1988) (rigid phosphates on metals).

In one aspect, the oligonucleotide is bound to the nanodisks via a functional group moiety. See International Patent Application No. US2008/55133, which is herein incorporated by reference. The oligonucleotides are modified to incorporate a leaving group at one distinct location and a functional group at a second distinct location. In some embodiments, the leaving group is toward one end of the oligonucleotide and the functional group is at an opposite end of the oligonucleotide. In specific embodiments, the leaving group is at one terminus of the oligonucleotide and the functional group is at an opposite terminus. The leaving group and functional group moiety can be attached at any portion of the oligonucleotide capable of being modified to have a leaving group and/or a functional group moiety.

Examples of sites on the oligonucleotide capable of being modified include, but are not limited to, a hydroxyl, phosphate, or amine. In some embodiments, the oligonucleotide has an unnatural nucleobase which incorporates a leaving group and/or a functional group moiety for attachment to a nanoparticle surface. In various aspects, the functional group is a spacer. In these aspects, the spacer is an organic moiety, a polymer, a water-soluble polymer, a nucleic acid, a polypeptide, and/or an oligosaccharide. Methods of functionalizing the oligonucleotides to attach to a surface of a nanoparticle are well known in the art. See Whitesides, Proceedings of the Robert A. Welch Foundation 39th Conference On Chemical Research Nanophase Chemistry, Houston, Tex., pages 109-121 (1995). See also, Mucic et al. Chem. Comm. 555-557 (1996) (describes a method of attaching 3′ thiol DNA to flat gold surfaces; this method can be used to attach oligonucleotides to nanoparticles). The alkanethiol method can also be used to attach oligonucleotides to other metal, semiconductor and magnetic colloids and to the other nanoparticles listed above. Other functional groups for attaching oligonucleotides to solid surfaces include phosphorothioate groups (see, e.g., U.S. Pat. No. 5,472,881 for the binding of oligonucleotide-phosphorothioates to gold surfaces), substituted alkylsiloxanes (see, e.g. Burwell, Chemical Technology, 4:370-377 (1974) and Matteucci and Caruthers, J. Am. Chem. Soc., 103:3185-3191 (1981) for binding of oligonucleotides to silica and glass surfaces, and Grabaretal., Anal. Chem., 67:735-743 for binding of aminoalkylsiloxanes and for similar binding of mercaptoaklylsiloxanes). Oligonucleotides terminated with a 5′ thionucleoside or a 3′ thionucleoside may also be used for attaching oligonucleotides to solid surfaces. The following references describe other methods which may be employed to attached oligonucleotides to nanoparticles: Nuzzo et al., J. Am. Chem. Soc., 109:2358 (1987) (disulfides on gold); Allara and Nuzzo, Langmuir, 1:45 (1985) (carboxylic acids on aluminum); Allara and Tompkins, J. Colloid Interface Sci., 49:410-421 (1974) (carboxylic acids on copper); Iler, The Chemistry Of Silica, Chapter 6, (Wiley 1979) (carboxylic acids on silica); Timmons and Zisman, J. Phys. Chem., 69:984-990 (1965) (carboxylic acids on platinum); Soriaga and Hubbard, J. Am. Chem. Soc., 104:3937 (1982) (aromatic ring compounds on platinum); Hubbard, Acc. Chem., Res., 13:177 (1980) (sulfolanes, sulfoxides and other functionalized solvents on platinum); Hickman et al., J. Am. Chem. Soc., 111:7271 (1989) (isonitriles on platinum); Maoz and Sagiv, Langmuir, 3:1045 (1987) (silanes on silica); Maoz and Sagiv, Langmuir, 3:1034 (1987) (silanes on silica); Wasserman et al., Langmuir, 5:1074 (1989) (silanes on silica); Eltekova and Eltekov, Langmuir, 3:951 (1987) (aromatic carboxylic acids, aldehydes, alcohols and methoxy groups on titanium dioxide and silica); Lec et al., J. Phys. Chem., 92:2597 (1988) (rigid phosphates on metals).

In one embodiment, the oligonucleotide has a disulfide functionality toward one end. This functional group can be achieved using, e.g., a dithiol phosphoramidite nucleobase (e.g., such as DTPA sold by Glen Research, Sterling, Va., USA). Selection of DTPA as functional group of the oligonucleotide is preferred because a free thiol may react with the leaving group end of the oligonucleotide to form self-aggregates of the oligonucleotide. However, any combination of functionality capable of attaching to a nanodisk code surface and leaving group moiety is contemplated which is stable under the disclosed conditions and able to provide the oligonucleotide-modified nanodisk codes.

### Molecule Attachment to Reporter Oligonucleotide

In one aspect, the oligonucleotide of the reporter oligonucleotide disclosed herein is modified with a leaving group at a distinct location. A leaving group, as used herein, refers to a moiety which is readily susceptible to nucleophilic attack by a nucleophile. Typical leaving groups include, but are not limited to, tosyl, mesyl, trityl, substituted trityl, nitrophenyl, chlorophenyl, fluorenylmethoxy carbonyl, and succinimidyl. Modification of a 3′ or 5′ end of an oligonucleotide to provide a leaving group functionality is well known in the art. See, e.g., WO 93/020242 for methods of modifying an oligonucleotide with a leaving group.

A molecule is attached to the reporter molecule via nucleophilic displacement of the leaving group on the oligonucleophile. Nucleophiles on the molecule can be, for example, an amine, a hydroxyl, a carboxylate, a thiol, or any other moiety capable of displacing a leaving group. Conditions sufficient to permit displacement of a leaving group by a nucleophile are easily determined by one of skill in the chemical arts.

In some embodiments, the molecule disclosed herein is a spectroscopic label. In one aspect, the molecule is a Raman-active label such as Cy3, Cy5, and TAMRA.

### Detection Assays

The nanodisk codes can be modified for use in analyte detection schemes. As used herein “molecule-modified nanodisk code” refers a nanodisk code having a molecule attached to its surface. The disclosed molecule-modified nanodisk codes can be used in detection assays, such as the bio barcode assay. See, e.g., U.S. Pat. Nos. 4,177,253; 4,672,040; 5,104,791; 5,512,439; 6,268,222; 6,361,944; 6,417,340; 6,495,324; 6,506,564; 6,582,921; 6,602,669; 6,610,491; 6,678,548; 6,677,122; 6,682,895; 6,709,825; 6,720,147; 6,720,411; 6,750,016; 6,759,199; 6,767,702; 6,773,884; 6,777,186; 6,812,334; 6,818,753; 6,828,432; 6,827,979; 6,861,221; 6,878,814, 6,974,669; 7,323,309; and U.S. Publication Nos. 2001/0031469; 2002/0146745; and 2004/0209376; and International Patent Publication No. WO 05/003394, each of which is incorporated herein by reference in its entirety. Other detection assays for which an immobilized molecule is of use are also contemplated. Non-limiting examples of such assays include immuno-PCR assays; enzyme-linked immunosorbent assays, Western blotting, indirect fluorescent antibody tests, change in solubility, change in absorbance, change in conductivity; and change in Raman or IR spectroscopy. (See e.g., Butler, J. Immunoassay, 21(2 & 3):165-209 (2000); Herbrink, et al., Tech. Diagn. Pathol. 2:1-19 (1992); and U.S. Pat. Nos. 5,635,602 and 5,665,539, each of which is incorporated herein by reference).

The nanodisk code can be modified with a wide variety of biomolecules, such as, for example, oligonucleotides, antigens, antibodies, polymers, polypeptides, polysaccharides, and the like. Methods for modifying a surface to attach such biomolecules are known in the art, e.g., in U.S. Patent Publications 2006/0051798; 2006/0040286; 2005/0037397; 2004/0131843; 2004/0110220; 2004/0086897; 2004/0072231; 2004/0038255; 2003/0207296; 2003/0180783; 2003/0148282; 2003/0143538; 2003/0129608; 2003/0124528; 2003/0113740; 2003/0087242; 2003/0068622; 2003/0059777; 2003/0054358; 2003/0049631; 2003/0049630; 2003/0044805; 2003/0022169; 2002/0192687; 2002/0182613; 2002/0182611; 2002/0177143; 2002/0172953; 2002/0164605; 2002/0160381; 2002/0155462; 2002/0155461; 2002/0155459; 2002/0155458; 2002/0155442; 2002/0146720; 2002/0137072; 2002/0137071; 2002/0137070; 2002/0137058; 2002/0127574; each of which is incorporated herein in its entirety by reference. The choice of biomolecule to modify the surface of the nanodisk code will depend upon the target analyte, and such choice can be easily made by one of skill in the art. As used herein, the term “target analyte” refers to an analyte of interest which is detectable using a molecule-modified nanodisk code. Typically, the target analyte is an oligonucleotide, but can be any analyte [of interest] which is detectable by a molecule-modified nanodisk code. Nonlimiting examples of target analytes include oligonucleotides, antigens, antibodies, polypeptides, polymers, ionic compounds, metals, metal ions, and ligands. In one aspect, for detection of an oligonucleotide target analyte, the surface of the nanodisk code can be modified with a complementary oligonucleotide, and in another aspect, for detection of an antigen, the surface of the nanodisk code can be modified with an appropriate antibodies.

The molecule-modified nanodisk code is mixed with a sample containing or suspected of containing a target analyte under conditions to permit a binding of the analyte to the molecule-modified nanodisk code. The binding of the analyte to the molecule-modified nanodisk code will produce a change that can be detected, termed a “detection event.” Depending upon the assay being employed, that detection event can be a change in fluorescence (e.g., in embodiments where a fluorescent label used); a change in absorbance, a change in Raman spectroscopy; a change in electrical properties (e.g., increase or decrease in ability of sample or molecule-modified nanoparticle to conduct electricity); a change in light scattering; a change in solubility (e.g., analyte binding to the molecule-modified nanodisk code causes it to participate out of the assay solution), or some other change in physical or chemical properties that can be detected using known means. The detection event can be detected using a variety of analytic techniques, such as, for example, Raman spectroscopy, liquid chromatography, gas chromatography, mass spectrometry, gel electrophoresis, capillary electrophoresis, nuclear magnetic resonance, PCR, and the like. The presence or absence of the detection event corresponds to the presence or absence of the target analyte.

Analytes can be detected at very low concentrations using the disclosed methods. In some embodiments, the analyte is present at a concentration as low as 100 fM with a dynamic range over 10 orders of magnitude. In various embodiments, the concentration of the analyte can be determined by comparing the detection event, e.g., change in absorbance, Raman signal intensity, or emission, and comparing that result to a calibration curve.

In one aspect, the molecule-modified nanodisk code is used in a three-strand sandwich assay. In various embodiments, the nanodisk code is functionalized with an oligonucleotide that is complementary to a first portion of a target oligonucleotide sequence. A reporter oligonucleotide, which contains a spectroscopic label, for example, a Raman label, includes an oligonucleotide that is complementary to a second portion of the target oligonucleotide. The oligonucleotide-modified nanodisk code, the reporter oligonucleotide, and a sample containing, or suspected of containing, the target oligonucleotide are mixed under conditions effective for hybridization of the oligonucleotide on the oligonucleotide-modified nanodisk code and the reporter oligonucleotide with the target oligonucleotide. The hybridization is a binding event that produces a detectable event. The presence or absence of the detectable event corresponds to the presence or absence of the target oligonucleotide. In one aspect, Raman spectroscopy is used to detect the detectable event. When Raman spectroscopy is used, the binding event brings the reporter oligonucleotide into Raman hotspots inherent to the nanodisk code structure, which allows the binding event to be detected by scanning or confocal Raman imaging.

In one aspect, the intensity of the detectable event is correlated to a concentration of the target oligonucleotide in the sample. In one aspect, correlation is accomplished by inclusion of known concentrations of one or more molecules (for example, an internal standard). In another aspect, correlation is accomplished by referencing the intensity detection invention of an unknown amount of target oligonucleotide with a standard curve generated from measurement of known amounts of the target. Techniques well known to those of skill in the art can be used in the creation of a standard curve and in the calculations of concentrations of the target oligonucleotide.

Referring to FIG. 1B, in one aspect, the reporter oligonucleotide is immobilized on a nanoparticle and a nanoparticle-target-nanodisk code sandwich assay 6 is performed. Immobilization of the reporter oligonucleotide on a nanoparticle can enhance detection of the detectable event as compared to the three-strand sandwich assay. The reporter oligonucleotide can be immobilized on the nanoparticle using the above described known methods for attaching an oligonucleotide to a nanoparticle. Examples of nanoparticles, include, but are not limited to indium-tin-oxide, titanium, platinum, titanium tungstide, gold, silver, nickel, copper, and mixtures thereof.

In one aspect, multiple target oligonucleotides having different sequences are detected using oligonucleotide-modified nanodisk codes. For example, two distinct target oligonucleotides, a first target and a second target, may be detected using first and second nanodisk codes, each having different binary encodings. The first nanodisk code is functionalized with an oligonucleotide that is complementary to a first portion of the first target. The second nanodisk code is functionalized with an oligonucleotide that is complementary to a first portion of the second target. First and second reporter oligonucleotides that are complementary to a second portion of the first and second targets, respectively, are provided. The first and second reporter oligonucleotides each have a distinct reporter molecule.

A sample containing, or suspected of containing, the target oligonucleotides, oligonucleotide-modified nanodisk codes, and the reporter oligonucleotides are mixed to allow contact. The first target oligonucleotide hybridizes with the first oligonucleotide-modified nanodisk code and the second target oligonucleotide hybridizes with a second oligonucleotide-modified nanodisk code. Each binding event produces a detection event. In one embodiment, the detection events are detected by Raman spectroscopy. The Raman image can contain full spectral information for both the reporter molecules, or the Raman image can be filtered to specifically monitor the distinct peak from a single reporter molecule. Thus, the binding events of both target oligonucleotides can be monitored to determine the presence and/or concentration of each target.

### Detection Assay Kit

The detection of target analytes using the nanodisk codes can be included in a kit. The kit includes a plurality of molecule-modified nanodisk codes each functionalized with distinct moieties and each having distinct encodings such that different target analytes can be detected. The kit can further include instructions.

Additional aspects and details of the invention will be apparent from the following examples, which are intended to be illustrative rather than limiting.

### EXAMPLES

### Preparation of Multisegmented Nanorods

Au—Ni nanorods were synthesized by template directed electrochemical synthesis (S. J. Hurst, E. K. Payne, L. Qin, C. A. Mirkin, Angew. Chem. Int. Ed. 45, 2672-2692 (2006); C. R. Martin, Science 266, 1961-1966 (1994); G. E. Possin, Rev. Sci. Instrum. 41, 772-774 (1970)). Ag was evaporated on the back of Anodisc® anodic aluminum oxide membranes from Whatman and placed in an electrochemical cell, which contained a Pt counterelectrode and a Ag/AgCl reference electrode. In all experiments, commercially available 1025 Silver, Nickel Sulfamate SEMI Bright RTU (Ni) and Orotemp 24RTU (Au) electroplating solutions from Technic Inc. were used for electrochemical deposition. The total charge passed during deposition determined the desired nanorod structure. Ag was deposited as an initial electrical contact layer under DC current at −800 mV (vs Ag/AgCl). Ni was deposited under DC current at a −800 mV potential, while Au was plated at −900 mV. The charge and length of each segment are shown in Table 1, wherein gray cells contain values for Au, and black and white cells contain values for Ni segments for separation gaps and disk gaps, respectively.

TABLE 1

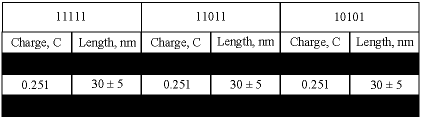

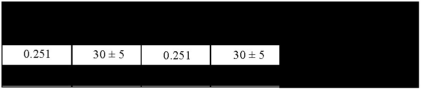

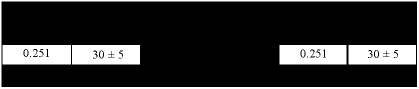

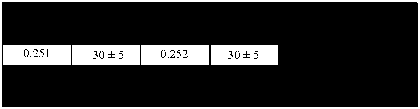

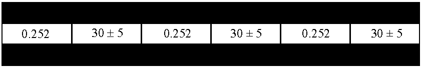

As shown in Table 1, the AU segments were approximately 120 nm long and deposited in pairs that were separated by approximately 30 nm long segments of Ni. Each of the AU pairs was separated by approximately 1 μm long segments of Ni. The deposition process was repeated a number of times to generate a multisegmented nanorod with anywhere from 6 to 10 Au sections (3 to 5 disk pairs). Referring to FIGS. 1B and 6D, the relative locations of each nanodisk pairs can be altered by varying the length of the Au and Ni segments during electrochemical deposition.

### Preparation of Nanodisk Codes Structures Using on Wire Lithography

After removal of the alumina template and the silver backing, the Au—Ni nanorods were dispersed onto piranha pretreated glass slides and coated with a 50 nm thick SiO₂ backing using plasma enhanced chemical vapor deposition (PE-CVD). The nanorods were then put in a test tube full of ethanol and sonicated to release the nanorods into the ethanolic suspension. Nanorods with silica coating were then collected in ethanol and rinsed with pure ethanol and deionized water three times per solvent. The nanorod were subsequently treated with 1:1 HCl etchant for one hour and rinsed three times each with water and ethanol, and finally stored in ethanol for further usage.

Referring again to FIG. 1B, the Ni segments were subsequently wet-chemically etched, leaving a linear array of Au nanodisk pairs bridged on one hemicylindrical side by a thin silica backing. Energy dispersive X-ray spectroscopy was used to confirm the total removal of the Ni sacrificial metal, which implies that the disk gaps between two Au nanodisks are empty (L. Qin, S. Park, L. Huang, C. A. Mirkin, Science 309, 113 (2005)). OWL generates an architecture known to give maximum Raman enhancement for nanostructures of this type (L. Qin et al., Proc. Natl. Acad. Sci. U.S.A. 103 13300-13303 (2006)).

This approach creates SERS-optimized Au nanodisk codes consisting of spatially separated disk pairs. A binary coding scheme can be assigned to these disk pair arrays, where the presence of a disk pair is represented by the number one, and the absence of a disk pair is represented by a zero. Referring to FIG. 6B, for example, the middle (third) disk pair in five disk pair array was intentionally skipped by depositing Ni in place of an Au disk pair to a 11011-encoded nanodisk code. Referring to FIG. 6C, a 10101-encoded nanodisk code was generated by replacing the second and fourth Au disk pairs with Ni. Referring to FIG. 1A, an encoding scheme based solely on the location and number of disk pairs for a 5 disk pair nanodisk code yields 13 distinct nanodisk codes when redundant sequences are eliminated.

Referring to FIGS. 6A to 6C, three representative nanodisk codes were fabricated and characterized by field emission scanning electron microscopy. FIG. 6A shows a 11111-encoded nanodisk code, FIG. 6 B shows a 11011-encoded nanodisk code, and FIG. 6C shows a 10101-encoded nanodisk code. While electron microscopy is a power characterization technique that allows for excellent spatial resolution, it is an impractical information readout method for an encoding scheme. Accordingly, the Au nanodisk codes were subsequently functionalized with a Raman label to yield Raman-active disk codes.

### Nanodisk Code Surface Functionalization

Referring to FIG. 1B, the nanodisk codes were subsequently functionalized with a Raman label. The Au nanodisk codes exhibit typical Au surface characteristics. Specifically, small molecules such as MB and pMA, as well as alkylthiol-modified molecules such as single stranded DNA, form stable surface adlayers. MB and pMA are two commonly used Raman chromophores (C. L. Haynes, A. D. McFarland, R. P. V. Duyne, Analytical Chemistry 77, 338A-346A (2005)). Raman active molecules were immobilized on the surface of the nanodisk code. Each spot in the array exhibits a SERS enhancement factor of 4.6×10⁸ (L. Qin et al., Proc. Natl. Acad. Sci. U.S.A. 103 13300-13303 (2006)).

11111-encoded nanodisk codes were functionalized with MB by centrifuging a 100 μL 11111-coded nanodisk code suspension containing approximately 2×10⁷ nanodisk codes and re-dispersing the nanodisk codes in 100 μL of 1 μM MB solution. The mixture was shaken for 48 hours at 1000 RPM on an oscillatory shaker, and then centrifuged at 5000 RPM to isolate the nanodisk codes. The nanodisk codes were subsequently rinsed with ethanol. The nanodisk code dispersion, centrifugation, and rising processes were repeated three times before the nanodisk codes were dried on a piranha pre-treated glass slide.

Nanodisk codes were functionalized with pMA by first washing the nanodisk codes three times in ethanol, and then suspending in 1 mL of a 1 nM pMA solution. The suspension was shaken for at least 2 hours and then centrifuged to isolate the nanodisk codes. The nanodisk codes were washed with EtOH three times prior to Raman imaging.

### Confocal Raman Microscope

Referring to FIG. 1C, the Raman-active nanodisk codes were characterized by scanning confocal Raman microscopy by integrating the entire spectral intensity over the approximately 139 to 2789 cm⁻¹ range. Raman spectra and images were recorded with a confocal Raman microscope (CRM200 WiTec) equipped with a piezo scanner and 100× microscope objectives (NA=0.90, Nikon). The spatial resolution is 400 nm in this example.

Samples were excited with a He—Ne laser (632.8 nm, Coherent Inc.) with a spot size of approximately 1 μm and a power density of approximately 104 W/cm2 incident on the samples. For a typical Raman image with a scan range of 15 μm×15 μm, complete Raman spectra were acquired on every pixel with an integration time of 0.1 s per spectrum and an image resolution of 100 pixel ×100 lines.

In this mode, the disk pair features appear as fully resolved, non-overlapping bright spots against a dark, smooth background in both two and three dimensional images. The full Raman spectrum provides Raman fingerprint information to accurately assign the labeled nanodisk code.

### Comparison of Raman-Active Nanodisk Codes to Raman-Active Conventional Striped Metal Barcodes

A comparison of Raman-active nanodisk codes to conventional striped metal barcodes functionalized with a Raman label was performed to demonstrate that the Raman characterization approach does not work with conventional striped metal barcodes. An aqueous solution of nanorods (analogous to striped barcodes) and 11111-encoded Au nanodisk codes made from these nanorods were prepared and concurrently labeled with pMA. By simultaneously labeling both structures in one solution, potential batch-to-batch differences in functionalization can be prevented.

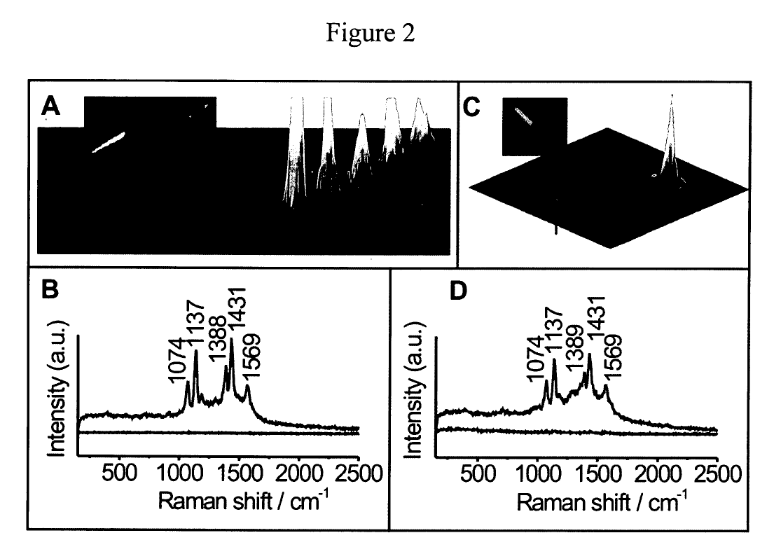

Referring to FIGS. 2A and 2C, both structures were then characterized using dark field microscopy and scanning Raman spectroscopy. Each of the five disk pairs of the 11111-encoded nanodisk code exhibited a strong Raman response, while the nanorod exhibited almost no signal intensity. The signal intensity of the spectra resulting from the Au nanodisk codes was 142,000 CCD counts higher than the spectra corresponding to the nanorods. The signal intensity was calculated by numerically integrating the spectra associated with a specific location on the nanorod or nanodisk code (see arrows in FIG. 2A).

Referring to FIGS. 2B and 2D, to determine if the signal difference was due to differences in surface area, a nanorod structure that contained both a single disk pair and a long AU nanorod segment was prepared. The surface area ratio between the nanorod segment and the disk pair was approximately 4.5:1 (FIG. 6E more clearly shows the structure of the nanorod structure). The nanorod structure was functionalized with pMA. The signal intensity from the disk pair was 91,000 CCD counts higher than the nanorod segment, despite the much larger surface area of the nanorod segment (and the correspondingly greater number of chromophores on the nanorod segment).

Nanodisk Code DNA Probe Preparation with Raman Dye Surface Functionalization

The binary physical encoding coupled with the high sensitivity Raman readout makes the nanodisk codes capable of being used as probes in biological detection schemes. The surface of the AU nanodisk codes can be functionalized with nearly any thiol-containing or surface-binding moiety, biological molecules such as cysteine-containing proteins or thiol-modified single strand oligonucleotides can be easily anchored to their surfaces (S. I. Stoeva, J.-S. Lee, J. E. Smith, S. T. Rosen, C. A. Mirkin, J. Am. Chem. Soc. 128, 8378-8379 (2006); N. L. Rosi, C. A. Mirkin, Chem. Rev. 105, 1547-1562 (2005); J.-M. Nam, C. S. Thaxton, C. A. Mirkin, Science 301, 1884-1886 (2003)). Nanodisk codes were prepared for use in a three-stranded sandwich assay for nucleic acid detection. Thiol-modified single stranded DNA molecules were attached to the nanodisk code surfaces according to previously published protocols used for gold spherical nanoparticles (C. S. Thaxton, H. D. Hill, D. G. Georganopoulou, S. I. Stoeva, C. A. Mirkin, Anal Chem. 24, 8174-8178 (2005)).

Lyophilized, desalted DNA was received from Integrated DNA Technologies Inc. and resuspended in nuclease-free water. The DNA was divided into 2 OD sections, lyophilized, and stored for further use at −80° C. Upon use, the stored DNA was resuspended in a cleaving solution (0.1 M dithiothreitol in 0.17 M phosphate buffer (PB) at pH 8). After 2 hours, the DNA was purified with a NAP-5 column from GE healthcare flushed with DI water.

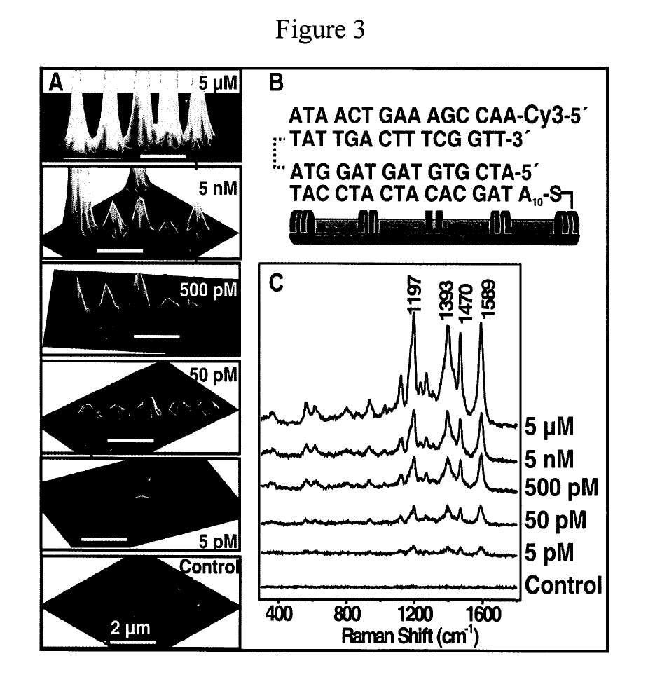

Referring to FIG. 3B, the oligonucleotides contained a sequence complementary to one-half of a target single stranded DNA sequence. The remaining half of the target sequence was complementary to a reporter oligonucleotide, which contained a Raman-active label (Cy3 or TAMRA).

The nanodisk codes were washed an additional three times with ethanol and three more times with water. Approximately 2 OD purified DNA was combined with the nanodisk code solution. After 30 minutes, sodium dodecylsulfate (SDS) and PB were added to buffer the solution to 0.01% SDS (w/v) and 0.01 M PB. After an additional 30 minutes NaCl was added in 5 increments spaced 30 minutes apart to bring the solution to a final salt concentration of 0.3 M. The solution was allowed to mix for 48 hours at 1000 RPM, 23° C.

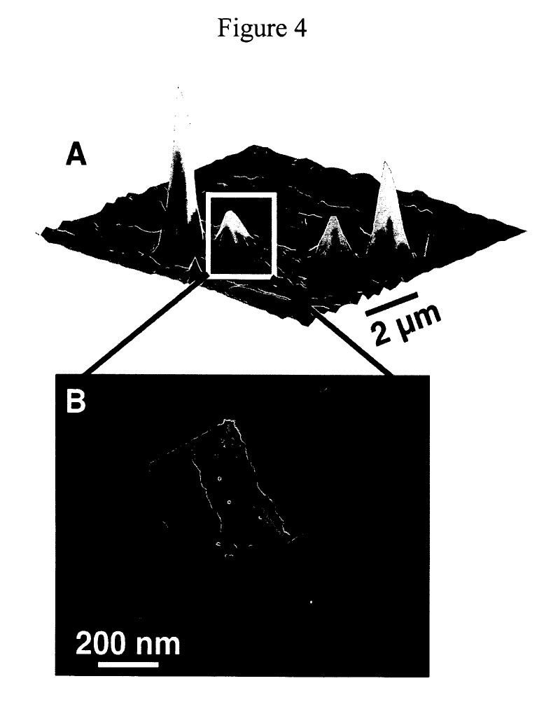

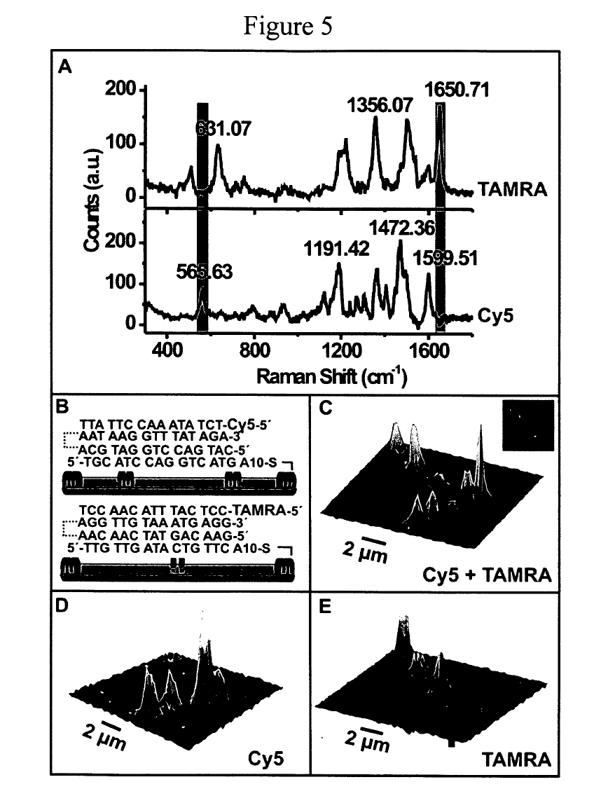

For the detection assay, the oligonucleotide-modified nanodisk codes were washed 3 times with 0.01% SDS/0.01 M PB/0.3M NaCl buffer to form an approximately 20 fM solution of oligonucleotide-modified nanodisk codes in phosphate-buffered saline. The solution of oligonucleotide-modified nanodisk code was combined with a given target concentration of DNA strands and a 40 fold stoichiometric excess dye-label reporting strands and was left to stand with occasional mixing at either 4° C. (FIG. 4) or 37° C. (FIG. 5) for 8 h.

The target hybridized to the oligonucleotide-modified nanodisk codes. This binding event brought the reporter oligonucleotide into the Raman hotspots inherent to the nanodisk code structures. The disk pairs generated a SERS enhancement factor of approximately 8 orders of magnitude, making the binding event detectable by scanning or confocal Raman imaging.

Referring to FIG. 3, this approach was used to detect target DNA at concentrations ranging from approximately 5 μM to 5 pM. Referring to FIGS. 3A and 3C, a control experiment containing the same amount of Raman-active label and oligonucleotide-modified nanodisk codes, but without target DNA did not show a discernable Raman signal. Thus, the assay based upon the nanodisk codes and scanning or confocal Raman readout has a reasonably low detection limit when Raman-active labels such as Cy3, Cy5, and TAMRA are used.

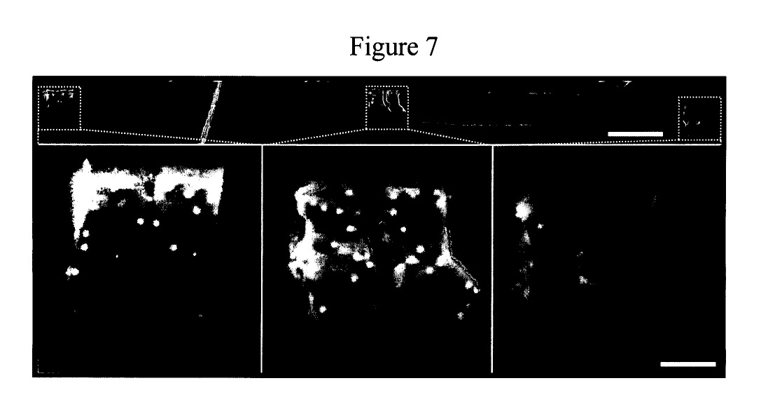

Additional sensitivity can be gained by immobilizing the Raman-active reporter oligonucleotides on AU nanoparticles. 250 μL of 13 nm Au nanoparticles from Ted Pella was diluted with Nanopure water to 1 mL and functionalized in an identical manner to the nanodisk codes. This generated a 100-fold increase in signal intensity for one binding event due to the approximately 100 additional labeled strands being brought into the Raman hotspot per binding event. The nanoparticle probe also quenched the fluorescence of the Raman-active label, which may interfere with Raman scattering (C. L. Haynes, A. D. McFarland, R. P. V. Duyne, Analytical Chemistry 77, 338A-346A (2005)). Referring to FIGS. 4 and 7, the nanoparticle probe-target-nanodisk codes sandwich assay has a detection limit of approximately 100 fM.

Referring to FIG. 5B, the inherent multiplexing capability of the nanodisk codes was examined using the three-stand DNA detection system as described above. 11011-encoded nanodisk codes were functionalized with an oligonucleotide sequence (NDC₁₁₀₁₁) that was designed to be complementary to one-half of a target DNA (target₁₁₀₁₁). The complement to the second half of the target sequence contained a Cy5 reporter molecule (reporter₁₁₀₁₁). In a different solution, 10101-encoded nanodisk codes were functionalized with a second oligonucleotide sequence (NDC₁₀₁₀₁) that is complementary to one section of a second target DNA (target₁₀₁₀₁). The complement to the second half of the target sequence contained a TAMRA reporter molecule (reporter₁₀₁₀₁). The functionalized 11011- and 10101-encoded nanodisk codes, both target sequences, and both reporter oligonucleotides were mixed in the same solution, and the oligonucleotides were allowed to hybridize at 37° C.

Referring to FIG. 5C, when both target₁₁₀₁₁ and target₁₁₀₁₁ were present, positive Raman images were obtained for both the 11011- and the 10101-encoded nanodisk codes.

Referring to FIG. 5A, the 565.63 cm⁻¹ peak from the Cy5 label was specifically monitored by applying a filter to the signal output. Referring to FIG. 5D, this demonstrated that only target₁₁₀₁₁ and reporter₁₁₀₁₁ were present on the 11011-encoded nanodisk codes.

Referring to FIG. 5A, the 1650.71 cm⁻¹ peak from the TAMRA label was similarly monitored by applying a filter to the signal output. Referring to FIG. 5E, this demonstrated that only target₁₀₁₀₁ and reporter₁₀₁₀₁ were present on the 10101-encoded nanodisk codes.

The foregoing describes and exemplifies the invention but is not intended to limit the invention defined by the claims that follow. All of the methods disclosed and claimed herein can be made and executed without undue experimentation in light of the present disclosure. While the materials and methods of this invention have been described in terms of specific embodiments, it will be apparent to those of skill in the art that variations may be applied to the materials and/or methods and in the steps or in the sequence of steps of the methods described herein, without departing from the concept, spirit, and scope of the invention. More specifically, it will be apparent that certain agents which are both chemically and physiologically related may be substituted for the agents described herein while the same or similar results would be achieved. All such similar substitutes and modifications apparent to those of ordinary skill in the art are deemed to be within the spirit, scope, and concept of the invention as defined in the appended claims.

What is claimed:

1. A method of detecting an analyte in a sample, the method comprising:
mixing (a) a molecule-modified nanodisk code comprising at least two nanodisks separated by a disk gap to form a nanodisk pair, a separation gap, and the molecule attached to a portion of a surface of the nanodisk code with (b) the sample under conditions to permit binding of the analyte to the molecule; and,
detecting the analyte bound to the molecule-modified nanodisk code, wherein the binding of the analyte to the molecule-modified nanodisk code produces a detection event;
wherein an arrangement of the nanodisk pair and the separation gap encodes the nanodisk code.

2. The method of claim 1, wherein the molecule is a biomolecule.

3. The method of claim 2, wherein the biomolecule is selected from the group consisting of a protein, a peptide, an antibody, a lipid, a carbohydrate, and combinations thereof.

4. The method of claim 1, wherein the nanodisks each have a thickness of about 20 nm to about 500 nm.

5. The method of claim 1, wherein the disk gap is about 2 to 500 nm.

6. The method of claim 1, wherein a separation gap length is about three times longer than a total length of the nanodisk code.

7. The method of claim 1, wherein the nanodisk code further comprises a spectroscopic label attached to at least a portion of a surface of the nanodisk code.

8. The method of claim 7, wherein the spectroscopic label is a Raman chromophore.

9. The method of claim 8, wherein the Raman chromophore is one of methylene blue and p-dimethlyaminoazobenzene.

10. The method of claim 1, wherein the nanodisk code further comprises a coating disposed on one side of the nanodisk code.

11. The nanodisk code of claim 10, wherein the coating is silica.

12. The nanodisk code of claim 1, wherein the arrangement of the nanodisk pair and the separation gap encodes a binary encoding scheme, and the presence of a nanodisk pair represents a one and the absence of a nanodisk pair represents a zero.

13. A method of assaying for a target oligonucleotide in a sample, the method comprising:
mixing an oligonucleotide-modified nanodisk code, a reporter oligonucleotide and the sample under conditions to permit a binding of the target oligonucleotide to the oligonucleotide-modified nanodisk code and the reporter oligonucleotide; and,
detecting the target oligonucleotide bound oligonucleotide-modified nanodisk code and the reporter oligonucleotide, wherein the binding of the target oligonucleotide bound oligonucleotide-modified nanodisk code and the reporter oligonucleotide produces a detection event, and the presence or absence of the detection event corresponds to the presence or absence of the target oligonucleotide,
wherein the oligonucleotide-modified nanodisk code comprises at least two nanodisks separated by a disk gap to form a nanodisk pair, and at least one separation gap; and the arrangement of the nanodisk pair and the separation gap determines encodes the nanodisk code;
at least a portion of the oligonucleotide-modified nanodisk code surface is functionalized with an oligonucleotide that is at least partially complementary to a first portion of the target oligonucleotide; and,
the reporter oligonucleotide comprises a reporter molecule and an oligonucleotide that is at least partially complementary to a second portion of the target oligonucleotide.

14. The method of claim 13, further comprising measuring an intensity of the detection event; and,
correlating the detection event intensity to an amount of the target oligonucleotide present in the sample.

15. The method of claim 13, wherein the reporter oligonucleotide is attached to a nanoparticle.

16. The method of claim 15, wherein the nanoparticle is gold.

17. The method of claim 13, wherein the nanodisk pairs are gold.

18. The method of claim 13, wherein the nanodisks each have a thickness of about 20 nm to about 500 nm.

19. The method of claim 13, wherein the disk gap is about 2 nm to about 500 nm.

20. The method of claim 13, wherein a separation gap length is about three times longer than a total length of the nanodisk code.

21. The method of claim 13, wherein the nanodisk code further comprises a coating disposed on one side of the nanodisk code.

22. The nanodisk code of claim 21, wherein the coating is silica.

23. The method of claim 13, further comprising detecting the binding event using scanning or confocal Raman imaging.

24. The method of claim 13, wherein the reporter molecule is selected from the group consisting of Cy3, Cy5, and TAMRA.

25. The method of claim 13, wherein the arrangement of the nanodisk pair and the separation gap encodes a binary encoding scheme, and the presence of a nanodisk pair represents a one and the absence of a nanodisk pair represents a zero.

26. A method of assaying for a plurality of target oligonucleotides in a sample, the method comprising:
mixing the sample having, or suspected of having, first and second target oligonucleotides, a first oligonucleotide-modified nanodisk code, a second oligonucleotide-modified nanodisk code, a first reporter oligonucleotide, and a second reporter oligonucleotide under conditions to permit binding of the first target oligonucleotide to the first oligonucleotide-modified nanodisk code and the first reporter oligonucleotide and binding of the second target oligonucleotide to the second oligonucleotide-modified nanodisk code and the second reporter oligonucleotide;
detecting the first target oligonucleotide bound to the first oligonucleotide-modified nanodisk code and the first reporter oligonucleotide and the second target oligonucleotide bound to the second oligonucleotide-modified nanodisk code and the second reporter oligonucleotide, wherein the binding of the first target oligonucleotide to the first oligonucleotide-modified nanodisk code and the first reporter oligonucleotide produces a first detection event and the binding of the second target oligonucleotide to the second oligonucleotide-modified nanodisk code and the second reporter oligonucleotide produces a second detection event, and the presence or absence of the first detection event corresponds to the presence or absence of the first target oligonucleotide and the presence or absence of the second detection event corresponds to the presence or absence of the second target oligonucleotide;
wherein the first and second oligonucleotide-modified nanodisk codes each comprise at least two nanodisks separated by a disk gap to form a nanodisk pair, a separation gap, and an arrangement of the nanodisk pair and the separation gap encodes the nanodisk code,
at least a portion of a surface of the first oligonucleotide-modified nanodisk code is functionalized with a first oligonucleotide that is at least partially complementary to a first portion of the first target oligonucleotide,
at least a portion of a surface of the second oligonucleotide-modified nanodisk code is functionalized with a second oligonucleotide that is at least partially complementary to a first portion of the second target oligonucleotide.
the first reporter oligonucleotide comprises a first reporter molecule and an oligonucleotide that is at least partially complementary to a second portion of the first target oligonucleotide;
the second reporter oligonucleotide comprises a second reporter molecule and an oligonucleotide that is at least partially complementary to a second portion of the second target oligonucleotide.

27. The method of claim 26, further comprising measuring a intensity of at least one of the first and second detection events; and,
correlating the detection event intensity to one of a concentration of the first target oligonucleotide, a concentration of the second target oligonucleotide, or a concentration of both the first and second target oligonucleotides.

28. The method of claim 26, wherein the first reporter molecule is selected from the group consisting of Cy3, Cy5, and TAMRA.

29. The method of claim 28, wherein the second reporter molecule is selected from the group consisting of Cy3, Cy5, and TAMRA, and the second reporter molecule is different than the first reporter molecule.

30. The method of claim 26, wherein the first and second reporter oligonucleotides are each immobilized on a nanoparticle.

31. The method of claim 30, wherein the nanoparticle is gold.

32. The method of claim 26, wherein the arrangement of the nanodisk pairs and the separation gaps of the first and second nanodisk codes encode a binary encoding scheme, and the presence of a nanodisk pair represents a one and the absence of a nanodisk pair represents a zero.

33. The method of claim 32, wherein the encoding of the first nanodisk code is different than the encoding of the second nanodisk code.

34. The method of claim 33, wherein the nanodisks are gold.

35. A kit for detection of an analyte, comprising:
a plurality of molecule-modified nanodisk codes, wherein each molecule-modified nanodisk code comprises a nanodisk pair comprising two nanodisks separated by a disk gap, a separation gap, a molecule attached to at least a portion of a surface of the nanodisk code;
an arrangement of the nanodisk pair and the separation gap correspond to an encoding of the nanodisk code;
and each molecule-modified nanodisk code having a different molecule and encoding such that different analytes can be detected.

36. The kit of claim 35, further comprising instructions.

37. The kit of claim 35, wherein the molecule is a biomolecule.

38. The kit of claim 37, wherein the biomolecule is an oligonucleotide.

39. The kit of claim 35, wherein the arrangement of the nanodisk pair and the separation gap of each nanodisk codes encodes a binary encoding scheme, and the presence of a nanodisk pair represents a one and the absence of a nanodisk pair represent a zero.
